(19) United States
(12) Patent Application Publication
(10) Pub. No.: US 2015/0341979 A1
(43) Pub. Date: Nov. 26, 2015

(54) SENSOR ASSOCIATED DATA PROCESSING CUSTOMIZATION

(71) Applicants: Allied Telesis Holdings Kabushiki Kaisha, Tokyo (JP); ALLIED TELESIS, INC., Bothell, WA (US)

(72) Inventors: Joseph L. Gallo, Santa Cruz, CA (US); Ferdinand E. K. de Antoni, Manila (PH); Scott Gill, Taguig (PH); Daniel Stellick, Geneva, IL (US)

(21) Appl. No.: 14/488,229

(22) Filed: Sep. 16, 2014

Related U.S. Application Data
(63) Continuation-in-part of application No. 14/281,896, filed on May 20, 2014.
Application No. 14/281,896 is a continuation-in-part of application No. 14/281,901, filed on May 20, 2014.
Application No. 14/281,901 is a continuation-in-part of application No. 14/315,286, filed on Jun. 25, 2014.
Application No. 14/315,286 is a continuation-in-part of application No. 14/315,289, filed on Jun. 25, 2014.
Application No. 14/315,289 is a continuation-in-part of application No. 14/315,317, filed on Jun. 25, 2014.
Application No. 14/315,317 is a continuation-in-part of application No. 14/315,320, filed on Jun. 25, 2014.
Application No. 14/315,320 is a continuation-in-part of application No. 14/315,322, filed on Jun. 25, 2014.
Application No. 14/315,322 is a continuation-in-part of application No. 14/281,904, filed on May 20, 2014.
Application No. 14/281,904 is a continuation-in-part of application No. 14/336,994, filed on Jul. 21, 2014.
Application No. 14/336,994 is a continuation-in-part of application No. 14/337,012, filed on Jul. 21, 2014.
Application No. 14/337,012 is a continuation-in-part of application No. 14/284,009, filed on May 21, 2014.

(51) Int. Cl. H04W 84/18

(52) U.S. Cl. CPC H04W 84/18

(57) ABSTRACT

Systems, apparatuses, and methods described herein are configured for communicating with one or more sensors, receiving sensor associated data, processing, interpreting, etc., of the sensor associated data. The plurality of sensors may be of one or more sensor types.

### RELATED U.S. APPLICATIONS

This application is related to U.S. patent application Ser. No. 14/281,896 entitled “SENSOR BASED DETECTION SYSTEM”, by Joseph L. Gallo et al., (Attorney Docket No. 13-012-00-US), filed on 20 May 2014, which is incorporated by reference herein.

This application is related to U.S. patent application Ser. No. 14/281,901 entitled “SENSOR MANAGEMENT AND SENSOR ANALYTICS SYSTEM”, by Joseph L. Gallo et al., (Attorney Docket No. 13-013-00-US), filed on 20 May 2014, which is incorporated by reference herein.

This application is related to U.S. patent application Ser. No. 14/315,286 entitled “METHOD AND SYSTEM FOR REPRESENTING SENSOR ASSOCIATED DATA”, by Joseph L. Gallo et al., (Attorney Docket No. 13-14-00-US), filed on 25 Jun. 2014, which is incorporated by reference herein.

This application is related to U.S. patent application Ser. No. 14/315,289 entitled “METHOD AND SYSTEM FOR SENSOR ASSOCIATED MESSAGING”, by Joseph L. Gallo et al., (Attorney Docket No. 13-015-00-US), filed on 25 Jun. 2014, which is incorporated by reference herein.

This application is related to U.S. patent application Ser. No. 14/315,317 entitled “PATH DETERMINATION OF A SENSOR BASED DETECTION SYSTEM”, by Joseph L. Gallo et al., (Attorney Docket No. 13-018-00-US), filed on 25 Jun. 2014, which is incorporated by reference herein.

This application is related to U.S. patent application Ser. No. 14/315,320 entitled “GRAPHICAL USER INTERFACE OF A SENSOR BASED DETECTION SYSTEM”, by Joseph L. Gallo et al., (Attorney Docket No. 13-17-00-US), filed on 25 Jun. 2014, which is incorporated by reference herein.

This application is related to U.S. patent application Ser. No. 14/315,322 entitled “GRAPHICAL USER INTERFACE FOR PATH DETERMINATION OF A SENSOR BASED DETECTION SYSTEM”, by Joseph L. Gallo et al., (Attorney Docket No. 13-18-00-US), filed on 25 Jun. 2014, which is incorporated by reference herein.

This application is related to U.S. patent application No. UNFILED entitled “Graphical User Interface and Video frames for a Sensor Based Detection System”, by Joseph L. Gallo et al., (Attorney Docket No. 13-19-00-US), filed on UNFILED, which is incorporated by reference herein.

This application is related to U.S. patent application Ser. No. 14/281,904 entitled “EVENT MANAGEMENT SYSTEM FOR A SENSOR BASED DETECTION SYSTEM”, by Joseph L. Gallo et al. (Attorney Docket No: 13-020-00-US), filed on 20 May 2014, which is incorporated by reference herein.

This application is related to U.S. patent application Ser. No. 14/336,994 entitled “SENSOR GROUPING FOR A SENSOR BASED DETECTION SYSTEM”, by Joseph L. Gallo et al. (Attorney Docket No. 13-021-00-US), filed on 21 Jul. 2014, which is incorporated by reference herein.

This application is related to U.S. patent application Ser. No. 14/337,012 entitled “DATA STRUCTURE FOR A SENSOR BASED DETECTION SYSTEM”, by Joseph L. Gallo et at (Attorney Docket No. 13-22-00-US), filed on 21 Jul. 2014, which is incorporated by reference herein.

This application is related to U.S. patent application No. UNFILED entitled “Alert System of a Sensor Based Detection System”, by Joseph L. Gallo et al., (Attorney Docket No. 13-24-00-US), filed on UNFILED, which is incorporated by reference herein.

This application is related to U.S. patent application No. UNFILED entitled “Event Analysis and Event Rewind of a Sensor Based Detection System”, by Joseph L. Gallo et al., (Attorney Docket No. 13-25-00-US), filed on UNFILED, which is incorporated by reference herein.

This application is related to U.S. patent application No. UNFILED entitled “Time Chart of a Sensor Based Detection System”, by Joseph L. Gallo et al., (Attorney Docket No. 13-26-00-US), filed on UNFILED, which is incorporated by reference herein.

This application is related to Philippines Patent Application No. 14/281,904 entitled “A DOMAIN AGNOSTIC METHOD AND SYSTEM FOR THE CAPTURE, STORAGE, AND ANALYSIS OF SENSOR READINGS”, by Ferdinand E. K. de Antoni, (Attorney Docket No. 13-027-00-PH), filed on 23 May 2013, which is incorporated by reference herein.

This application is related to U.S. patent application Ser. No. 14/281,904 entitled “USER QUERY AND GAUGE-READING RELATIONSHIPS”, by Ferdinand E. K. de Antoni (Attorney Docket No. 13-027-00-US) and filed on 21 May 2014, which is incorporated by reference herein.

This application is related to U.S. patent application No, UNFILED entitled “Sensor based element manager (working)”, by Joseph L. Gallo et al., (Attorney Docket No. 13-033-00-US), filed on UNFILED, which is incorporated by reference herein.

This application is related to U.S. patent application No. UNFILED entitled “Sensor based response system (working)”, by Joseph L. Gallo et al., (Attorney Docket No. 13-034-00-US), filed on UNFILED, which is incorporated by reference herein.

### BACKGROUND

As technology has advanced, computing technology has proliferated to an increasing number of areas while decreasing in price. Consequently, devices such as smartphones, laptops, GPS, etc., have become prevalent in our community, thereby increasing the amount of data being gathered in an ever increasing number of locations. Unfortunately, most of the information gathered is used for marketing and advertising to the end user, e.g., smartphone user receives a coupon to a nearby Starbucks, etc., while the security of our community is left exposed and at a risk of terrorist attacks such as the Boston Marathon bombers.

### SUMMARY

Accordingly, a need has arisen for a solution to allow communication with one or more different types of sensors and processing, interpreting, etc., of sensor associated data from one or more different types of sensors.

Embodiments are configured for communicating with one or more sensors, receiving sensor associated data, and processing, interpreting, etc., of the sensor associated data. Embodiments may support defining how sensors are configured, how the sensors operate, and what sort of data to expect from the sensors. Embodiments are further configured for adding new or additional sensors to a system and configuring the system to handle the data from the new or additional sensors. Embodiments may be used for adding additional sensor states based on processing of sensor associated data. Embodiments may further support storage of sensor associated data of new sensor types, presenting of sensor associated data of new sensor types in a graphical user interface, sending messages based on the sensor associated data, etc.

One embodiment is directed to a method for processing sensor associated data. The method includes receiving configuration data associated with processing sensor associated data and receiving the sensor associated data. In some embodiments, the processing of the sensor associated data may be customized based on the configuration data. The method further includes determining a value based on the configuration data associated with processing the sensor associated data and storing the value. In some embodiments, the determining of the value is based on historical sensor associated data and the sensor associated data received from a sensor. In some embodiments, the value is further based on a change in a state of the sensor. In some embodiments, the value is based on a heuristic of the configuration data. In some embodiments, the value is associated with an event. In some embodiments, the method further includes displaying a graphical user interface configured for generating the configuration data.

Another embodiment is directed to a method for processing sensor associated data. The method includes receiving a first portion of configuration data associated with processing data associated with a first type of sensor and receiving a second portion of configuration data associated with processing data associated with a second type of sensor. The method further includes receiving a first sensor reading from a first sensor of the first type of sensor and receiving a second sensor reading from a second sensor of the second type of sensor. The method further includes determining a value based on the first portion of configuration data, the second portion of configuration data, the first sensor reading, and the second sensor reading and storing the value. In some embodiments, the value is based on a correlation between the first sensor reading and the second sensor reading. In some embodiments, the value is an event based on the correlation between the first sensor reading and the second sensor reading. In some embodiments, the value is based on an algorithm applied to the first sensor reading and the second sensor reading.

In some embodiments, the method further includes determining whether the value is within a threshold and in response to determining the value is within a threshold, sending the value. In some embodiments, the method further includes storing the first sensor reading and the second sensor reading. In some embodiments, the method further includes displaying a graphical user interface configured for generating the first portion of configuration data and the second portion of configuration data.

Another embodiment is directed to a system for processing sensor associated data. The system includes a data module configured to receive data associated with a plurality of sensors and a configuration receiving module configured for receiving configuration data associated with processing of the data associated with the plurality of sensors. The system further includes a determination module configured for determining a data point based on the configuration data associated with processing of the data associated with the plurality of sensors applied to the data associated with the plurality of sensors. In some embodiments, the plurality of sensors comprises a first sensor of a first sensor type and a second sensor of a second sensor type. In some embodiments, the data point is an event. In some embodiments, the system further includes a communication module for sending the data point. In some embodiments, the system further includes a configuration module for outputting configuration data associated with processing the data associated with the plurality of sensors. In some embodiments, the configuration module is further for displaying a graphical user interface for generating the configuration data associated with processing the data associated with the plurality of sensors.

These and various other features and advantages will be apparent from a reading of the following detailed description.

### BRIEF DESCRIPTION OF DRAWINGS

The embodiments are illustrated by way of example, and not by way of limitation, in the figures of the accompanying drawings and in which like reference numerals refer to similar elements.

FIG. 1 shows an exemplary operating environment of an exemplary sensor based detection system in accordance with some embodiments.

FIG. 2 shows an exemplary data flow diagram in accordance with some embodiments.

FIG. 3 shows an exemplary data flow diagram in accordance with some embodiments.

FIG. 4 shows an exemplary flow diagram of a process for processing data associated with a sensor in accordance with some embodiments.

FIG. 5 shows another exemplary flow diagram of a process for processing data from different sensor types in accordance with some embodiments.

FIG. 6 shows a block diagram of an exemplary computer system in accordance with some embodiments.

FIG. 7 shows a block diagram of another exemplary computer system in accordance with some embodiments.

### DETAILED DESCRIPTION

Reference will now be made in detail to various embodiments, examples of which are illustrated in the accompanying drawings. While the claimed embodiments will be described in conjunction with various embodiments, it will be understood that these various embodiments are not intended to limit the scope of the embodiments. On the contrary, the claimed embodiments are intended to cover alternatives, modifications, and equivalents, which may be included within the scope of the appended Claims. Furthermore, in the following detailed description numerous specific details are set forth in order to provide a thorough understanding of the claimed embodiments. However, it will be evident to one of ordinary skill in the art that the claimed embodiments may be practiced without these specific details. In other instances, well known methods, procedures, components, and circuits are not described in detail so that aspects of the claimed embodiments are not obscured.

Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of operations or steps or instructions leading to a desired result. The operations or steps are those utilizing physical manipulations of physical quantities. Usually, although not necessarily, these quantities take the form of electrical or magnetic signals capable of being stored, transferred, combined, compared, and otherwise manipulated in a computer system or computing device. It has proven convenient at times, principally for reasons of common usage, to refer to these signals as transactions, bits, values, elements, symbols, characters, samples, pixels, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “receiving,” “converting,” “transmitting,” “storing, “determining,” *sending,” “querying,” “providing,” “accessing,” “associating,” “configuring,” “initiating,” “customizing”, “mapping,” “modifying,” “analyzing,” “displaying,” “updating.” “reconfiguring,” “restarting,” or the like, refer to actions and processes of a computer system or similar electronic computing device or processor. The computer system or similar electronic computing device manipulates and transforms data represented as physical (electronic) quantities within the computer system memories, registers or other such information storage, transmission or display devices.

It is appreciated that present systems and methods can be implemented in a variety of architectures and configurations. For example, present systems and methods can be implemented as part of a distributed computing environment, a cloud computing environment, a client server environment, etc. Embodiments described herein may be discussed in the general context of computer-executable instructions residing on some form of computer-readable storage medium, such as program modules, executed by one or more computers, computing devices, or other devices. By way of example, and not limitation, computer-readable storage media may comprise computer storage media and communication media. Generally, program modules include routines, programs, objects, components, data structures, etc., that perform particular tasks or implement particular abstract data types. The functionality of the program modules may be combined or distributed as desired in various embodiments.

Computer storage media can include volatile and nonvolatile, removable and non-removable media implemented in any method or technology for storage of information such as computer-readable instructions, data structures, program modules, or other data, that are non-transitory. Computer storage media can include, but is not limited to, random access memory (RAM), read only memory (ROM), electrically erasable programmable ROM (EEPROM), flash memory, or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information and that can be accessed to retrieve that information.

Communication media can embody computer-executable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared and other wireless media. Combinations of any of the above can also be included within the scope of computer-readable storage media.

### Sensor Associated Data Processing Customization

Accordingly, a need has arisen for a solution to allow communication with one or more different types of sensors and processing, interpreting, etc., of sensor associated data from one or more different types of sensors.

Embodiments are configured for communicating with one or more sensors, receiving sensor associated data, and processing, interpreting, etc., of the sensor associated data. Embodiments may support defining how sensors are configured, how the sensors operate, and what sort of data to expect from the sensors. Embodiments are further configured for adding new or additional sensors to a system and configuring the system to handle the data from the new or additional sensors. Embodiments may be used for adding additional sensor states based on processing of sensor associated data. Embodiments may further support storage sensor associated data of new sensor types, presenting of sensor associated data of new sensor types in a graphical user interface, sending messages based on the new sensor types of sensor associated data, etc.

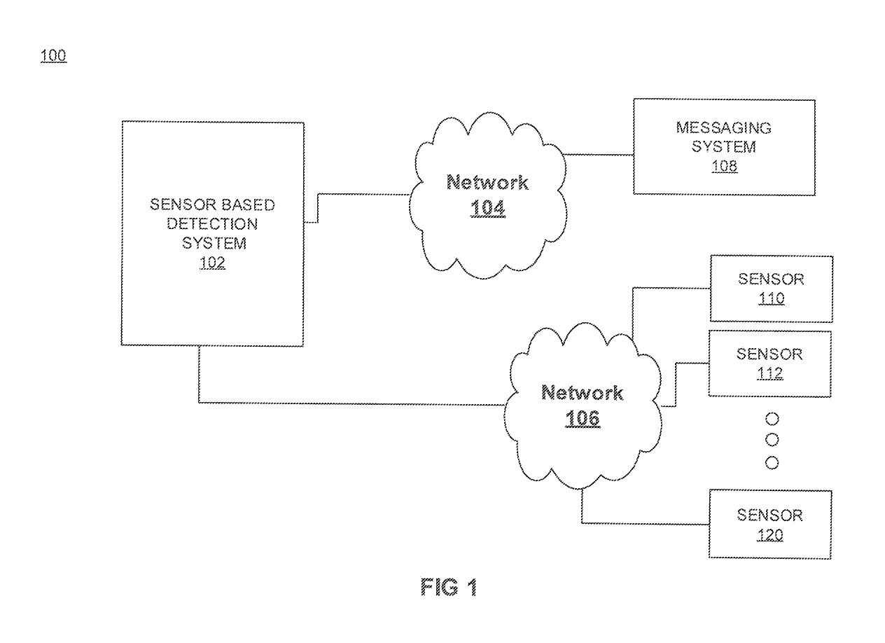

FIG. 1 shows an exemplary operating environment in accordance with some embodiments. The exemplary operating environment 100 includes a sensor based detection system 102, a network 104, a network 106, a messaging system 108, and sensors 110-120. The sensor based detection system 102 and the messaging system 108 are coupled to a network 104. The sensor based detection system 102 and messaging system 108 are communicatively coupled via the network 104. The sensor based detection system 102 and sensors 110-120 are coupled to a network 106. The sensor based detection system 102 and sensors 110-120 are communicatively coupled via network 106. Networks 104, 106 may include more than one network (e.g., intranets, the Internet, local area networks (LAN)s, wide area networks (WAN)s, etc.) and may be a combination of one or more networks including the Internet. In some embodiments, network 104 and network 106 may be a single network.

The sensors 110-120 detect a reading associated therewith, e.g., gamma radiation, vibration, etc., and transmit that information to the sensor based detection system 102 for analysis. The sensor based detection system 102 may use the information received and compare it to a threshold value, e.g., historical values, user selected values, etc., in order to determine whether a potentially hazardous event has occurred. In response to the determination, the sensor based detection system 102 may transmit the information to the messaging system 108 for appropriate action, e.g., emailing the appropriate personnel, sounding an alarm, tweeting an alert, alerting the police department, alerting homeland security department, etc. Accordingly, appropriate actions may be taken in order to avert the risk.

The sensors 110-120 may be any of a variety of sensors including thermal sensors (e.g., temperature, heat, etc.), electromagnetic sensors (e.g., metal detectors, light sensors, particle sensors, Geiger counter, charge-coupled device (CCD), etc.), mechanical sensors (e.g. tachometer, odometer, etc.), complementary metal-oxide-semiconductor (CMOS), biological/chemical (e.g., toxins, nutrients, etc.), etc. The sensors 110-120 may further be any of a variety of sensors or a combination thereof including, but not limited to, acoustic, sound, vibration, automotive/transportation, chemical, electrical, magnetic, radio, environmental, weather, moisture, humidity, flow, fluid velocity, ionizing, atomic, subatomic, navigational, position, angle, displacement, distance, speed, acceleration, optical, light imaging, photon, pressure, force, density, level, thermal, heat, temperature, proximity, presence, radiation. Geiger counter, crystal based portal sensors, biochemical, pressure, air quality, water quality, fire, flood, intrusion detection, motion detection, particle count, water level, surveillance cameras, etc. The sensors 110-120 may be video cameras (e.g., internet protocol (IP) video cameras, network coupled cameras, etc.) or purpose built sensors.

The sensors 110-120 may be fixed in location (e.g., surveillance cameras or sensors, camera, etc.), semi-fixed (e.g., sensors on a cell tower on wheels or affixed to another semi portable object), or mobile (e.g., part of a mobile device, smartphone, etc.). The sensors 110-120 may provide data to the sensor based detection system 102 according to the type of the sensors 110-120. For example, sensors 110-120 may be CMOS sensors configured for gamma radiation detection Gamma radiation may thus illuminate a pixel, which is converted into an electrical signal and sent to the sensor based detection system 102.

The sensor based detection system 102 is configured to receive data and manage sensors 110-120. The sensor based detection system 102 is configured to assist users in monitoring and tracking sensor readings or levels at one or more locations. The sensor based detection system 102 may have various components that allow for easy deployment of new sensors within a location (e.g., by an administrator, an operator, etc.) and allow for monitoring of the sensors to detect events based on user preferences, heuristics, etc. The events may be used by the messaging system 108 to generate sensor-based alerts (e.g., based on sensor readings above a threshold for one sensor, based on the sensor readings of two sensors within a certain proximity being above a threshold, etc.) in order for the appropriate personnel to take action. The sensor based detection system 102 may receive data and manage any number of sensors, which may be located at geographically disparate locations. In some embodiments, the sensors 110-120 and components of the sensor based detection system 102 may be distributed over multiple systems (e.g., physical machines, virtualized machines, a combination thereof, etc.) and a large geographical area.

The sensor based detection system 102 may track and store location information (e.g., board room B, floor 2, terminal A, etc.) and global positioning system (GPS) coordinates, e.g., latitude, longitude, etc. for each sensor or group of sensors. The sensor based detection system 102 may be configured to monitor sensors and track sensor values to determine whether a defined event has occurred, e.g., whether a detected radiation level is above a certain threshold, whether a detected bio-hazard level is above a certain threshold, etc., and if so then the sensor based detection system 102 may determine a route or path of travel that a dangerous or contraband material is taking around or within range of the sensors. For example, the path of travel of radioactive material relative to fixed sensors may be determined and displayed via a graphical user interface. It is appreciated that the path of travel of radioactive material relative to mobile sensors, e.g., smartphones, sensing device, etc., or relative to a mixture of fixed and mobile sensors may be similarly determined and displayed via a graphical user interface. It is appreciated that the analysis and/or the sensed values may be displayed in real-time or stored for later retrieval.

The sensor based detection system 102 may display a graphical user interface (GUI) for monitoring and managing sensors 110-120. The GUI may be configured for indicating sensor readings, sensor status, sensor locations on a map etc. The sensor based detection system 102 may allow review of past sensor readings and movement of sensor detected material or conditions based on stop, play, pause, fast forward, and rewind functionality of stored sensor values. The sensor based detection system 102 may also allow viewing of an image or video footage (e.g., motion or still images) corresponding to the sensors that had sensor readings above a threshold (e.g., based on a predetermined value or based on ambient sensor readings). For example, a sensor may be selected in a GUI and video footage associated with an area within a sensor's range of detection may be displayed, thereby enabling a user to see an individual or person transporting hazardous material. According to some embodiments, the footage is displayed in response to a user selection or it may be displayed automatically in response to a certain event, e.g., sensor reading associated with a particular sensor or group of sensors being above a certain threshold.

In some embodiments, sensor readings of one or more sensors may be displayed on a graph or chart for easy viewing. A visual map-based display depicting sensors may be displayed with the sensor representations and/or indicators, which may include color coding, shapes, icons, flash rate, etc., according to the sensors' readings and certain events. For example, gray may be associated with a calibrating sensor, green may be associated with a normal reading from the sensor, yellow may be associated with an elevated sensor reading, orange associated with a potential hazard sensor reading, and red associated with a hazard alert sensor reading.

The sensor based detection system 102 may determine alerts or sensor readings above a specified threshold (e.g., predetermined, dynamic, or ambient based) or based on heuristics and display the alerts in the graphical user interface (GUI). The sensor based detection system 102 may allow a user (e.g., operator, administrator, etc.) to group multiple sensors together to create an event associated with multiple alerts from multiple sensors. For example, a code red event may be created when three or more sensors within twenty feet of one another and within the same physical space have a sensor reading that is at least 40% above the historical values. In some embodiments, the sensor based detection system 102 may automatically group sensors together based on geographical proximity of the sensors, e.g., sensors of gates 1, 2, and 3 within terminal A at LAX airport may be grouped together due to their proximate location with respect to one another, e.g., physical proximity within the same physical space, whereas sensors in different terminals may not be grouped because of their disparate locations. However, in certain circumstances sensors within the same airport may be grouped together in order to monitor events at the airport and not at a more granular level of terminals, gates, etc.

The sensor based detection system 102 may send information to a messaging system 108 based on the determination of an event created from the information collected from the sensors 110-120. The messaging system 108 may include one or more messaging systems or platforms which may include a database (e.g., messaging, SQL, or other database), short message service (SMS), multimedia messaging service (MMS), instant messaging services, Twitter™ available from Twitter, Inc. of San Francisco, Calif., Extensible Markup Language (XML) based messaging service (e.g., for communication with a Fusion center), JavaScript™ Object Notation (JSON) messaging service, etc. For example, national information exchange model (NIEM) compliant messaging may be used to report chemical, biological, radiological and nuclear defense (CBRN) suspicious activity reports (SARs) to report to government entities (e.g., local, state, or federal government).

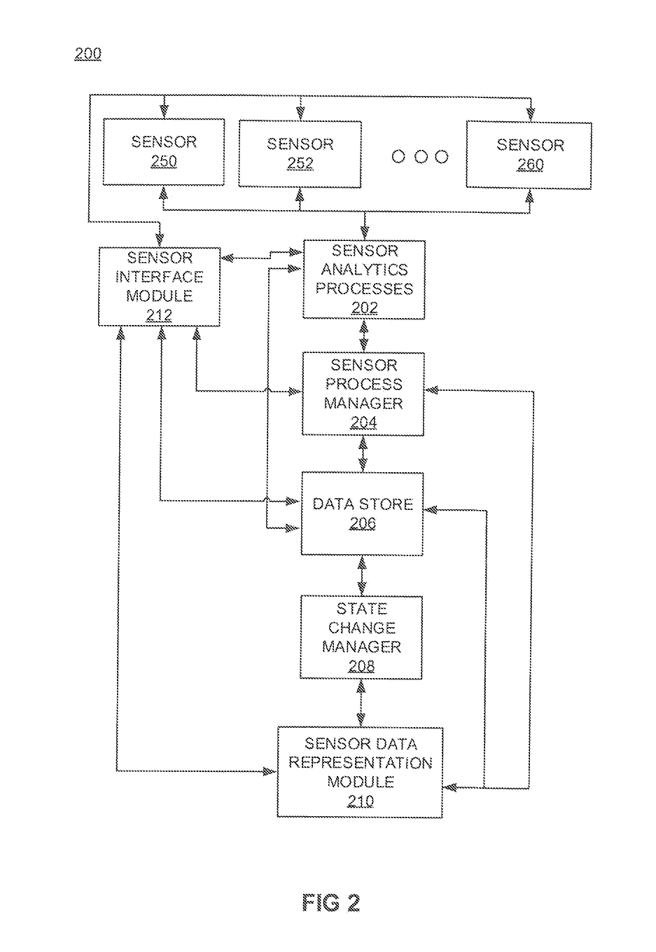

FIG. 2 shows an exemplary data flow diagram in accordance with some embodiments. Diagram 200 depicts the flow of data (e.g., sensor readings, raw sensor data, analyzed sensor data, etc.) associated with a sensor based detection system (e.g., sensor based detection system 102). Diagram 200 includes sensors 250-260, sensor analytics processes 202, a sensor process manager 204, a data store 206, a state change manager 208, a sensor data representation module 210, and the sensor interface module 212. In some embodiments, the sensor analytics processes 202, the sensor process manager 204, the state change manager 208, the sensor data representation module 210, and the sensor interface module 212 may execute on one or more computing systems (e.g., virtual or physical computing systems). The data store 206 may be part of or stored in a data warehouse.

The sensors 250-260 may be substantially similar to sensors 110-120 and may be any of a variety of sensors as described above. The sensors 250-260 may provide data (e.g., as camera stream data, video stream data, etc.) to the sensor analytics processes 202 and sensor interface module 212.

The sensor process manager 204 is configured to initiate or launch sensor analytics processes 202. The sensor process manager 204 is operable to configure each instance or process of the sensor analytics processes 202 based on configuration parameters (e.g., preset, configured by a user, etc.). In some embodiments, the sensor analytics processes 202 may be configured by the sensor process manager 204 to organize sensor readings over particular time intervals (e.g., 30 seconds, one minute, one hour, one day, one week, one year). It is appreciated that the particular time intervals may be preset or it may be user configurable. It is further appreciated that the particular time intervals may be changed dynamically. e.g., during run time, or statically. In some embodiments, a process of the sensor analytics processes 202 may be executed for each time interval. The sensor process manager 204 may also be configured to access or receive metadata associated with sensors 250-260 (e.g., geospatial coordinates, network settings, user entered information, etc.).

The sensor process manager 204 receives analyzed sensor data from sensor analytics processes 202. The sensor process manager 204 may then send the analyzed sensor data to the data store 206 for storage. The sensor process manager 204 may further send metadata associated with sensors 250-260 for storage in the data store 206 with the associated analyzed sensor data. In some embodiments, the sensor process manager 204 may send the analyzed sensor data and metadata to the sensor data representation module 210. In some embodiments, the sensor process manager 204 sends the analyzed sensor data and metadata associated with sensors 250-260 to the sensor data representation module 210. It is appreciated that the information transmitted to the sensor data representation module 210 from the sensor process manager 204 may be in a message based format.

In some embodiments, the sensor analytics processes 202 may then send the analyzed sensor data to the data store 206 for storage. The sensor analytics processes 202 may further send metadata associated with sensors 250-260 for storage in the data store 206 with the associated analyzed sensor data.

The state change manager 208 may access or receive analyzed sensor data and associated metadata from the data store 206. The state change manager 208 may be configured to analyze sensor readings for a possible change in the state of the sensor. It is appreciated that in some embodiments, the state change manager 208 may receive the analyzed sensor data and/or associated metadata from the sensor analytics processes 202 directly without having to fetch that information from the data store 206 (not shown).

The state change manager 208 may determine whether a state of a sensor has changed based on current sensor data and previous sensor data. Changes in sensors state based on the sensor readings exceeding a threshold, within or outside of a range, etc., may be sent to a sensor data representation module 210 (e.g., on a per sensor basis, on a per group of sensors basis, etc.). For example, a state change of the sensor 252 may be determined based on the sensor 252 changing from a prior normal reading to an elevated reading (e.g., above a certain threshold, within an elevated reading, within a dangerous reading, etc.) In another example, the state of sensor 250 may be determine not to have changed based on the sensor 252 having an elevated reading within the same range as the prior sensor reading. In some embodiments, the various states of sensors and associated alerts may be configured by a sensor process manager 204. For example, the sensor process manager 204 may be used to configure thresholds, ranges, etc., that may be compared against sensor readings to determine whether an alert should be generated. For example, the sensors 205-260 may have six possible states: calibrating, nominal, elevated, potential, warning, and danger. It is appreciated that the configuring of the sensor process manager 204 may be in response to a user input. For example, a user may set the threshold values, ranges, etc., and conditions to be met for generating an alert. In some embodiments, color may be associated with each state. For example, dark gray may be associated with a calibration state, green associated with a nominal state, yellow associated with an elevated state, orange associated with a potential state, and red associated with an alert state. Light gray may be used to represent a sensor that is offline or not functioning.

In some embodiments, the state change manager 208 is configured to generate an alert or alert signal if there is a change in the state of a sensor to a new state. For example, an alert may be generated for a sensor that goes from a nominal state to an elevated state or a potential state. In some embodiments, the state change manager 208 includes an active state table. The active state table may be used to store the current state and/or previous and thereby the active state table is maintained to determine state changes of the sensors. The state change manager 208 may thus provide real-time sensing information based on sensor state changes.

In some embodiments, the state change manager 208 may determine whether sensor readings exceed normal sensor readings from ambient sources or whether there has been a change in the state of the sensor and generate an alert. For example, with gamma radiation, the state change manager 208 may determine if gamma radiation sensor readings are from a natural source (e.g., the sun, another celestial source, etc.) or other natural ambient source based on a nominal sensor state, or from radioactive material that is being transported within range of a sensor based on an elevated, potential, warning, or danger sensor state. In some embodiment, it is determined whether the gamma radiation reading is inside a safe range based on a sensor state of nominal or outside of the safe range based on the sensor state of elevated, potential, warning, or danger.

In some embodiments, individual alerts may be sent to an external system (e.g., a messaging system 108). For example, one or more alerts that occur in a certain building within time spans of one minute, two minutes, or 10 minutes may be sent to a messaging system. It is appreciated that the time spans that the alerts are transmitted may be preset or selected by the system operator. In some embodiments, the time spans that the alerts are transmitted may be set dynamically, e.g., in real time, or statically.

The sensor data representation module 210 may access or receive analyzed sensor data and associated metadata from the sensor process manager 204 or data store 206. The sensor data representation module 210 may further receive alerts (e.g., on a per sensor basis, on per location basis, etc.) based on sensor state changes determined by the state change manager 208.

The sensor data representation module 210 may be operable to render a graphical user interface depicting sensors, sensor state, alerts, sensor readings, etc. The sensor data representation module 210 may display one or more alerts, which occur when a sensor reading satisfies a certain condition visually on a map, e.g., when a sensor reading exceeds a threshold, falls within a certain range, is below a certain threshold, etc. The sensor data representation module 210 may thus notify a user (e.g., operator, administrator, etc.) visually, audibly, etc., that a certain condition has been met by the sensors, e.g., possible bio-hazardous material has been detected, elevated gamma radiation has been detected, etc. The user may have the opportunity to inspect the various data that the sensor analytics processes 202 have generated (e.g. mSv values, bio-hazard reading level values, etc.) and generate an appropriate event case file including the original sensor analytics process 202 data (e.g. raw stream data, converted stream data, preprocessed sensor data, etc.) that triggered the alert. The sensor data representation module 210 may be used (e.g., by operators, administrators, etc.) to gain awareness of any materials (e.g., radioactive material, bio-hazardous material, etc.) or other conditions that travel through or occur in a monitored area.

In some embodiments, the sensor data representation module 210 includes location functionality operable to show a sensor, alerts, and events geographically. The location functionality may be used to plot the various sensors at their respective location on a map within a graphical user interface (GUI). The GUI may allow for rich visual maps with detailed floor plans at various zoom levels, etc. The sensor data representation module 210 may send sensor data, alerts, and events to a messaging system (e.g., messaging system 108) for distribution (e.g., other users, safety officials, etc.).

Alerts from one or more sensors may be grouped, aggregated, represented, and/or indicated as an event. An event may thus be associated with one or more alerts from one or more sensors. The event may be determined based on one or more conditions, rules, parameters, or heuristics applied to one or more alerts. For example, a single alert could be a fluke or a blip in a sensor reading. When multiple alerts occur, however, there is a high likelihood that something more significant is taking place. For example, multiple alerts occurring within the same area or within a certain proximity of one another or facility may indicate that a hazardous material is present in that area. In another example, five alerts that happen within the preceding one minute within the same building and on the same floor may be aggregated into an event. The event may then be sent to an external system or highlighted on a graphical user interface.

In some embodiments, an operator may be able to mark an alert, or series of alerts, as an “event.” The sensor data representation module 210 may allow a user (e.g., operator, administrator, etc.) to group multiple sensors together, e.g., via a text block field, via a mouse selection, via a dropdown menu, etc., to create an event associated with multiple alerts from a group of selected sensors. For example, a code red event may be created when three sensors or more within twenty feet of one another and within the same physical space have a sensor reading that is at least 40% above historical values. In some embodiments, the sensor based detection system 102 may automatically group sensors together based on the geographical proximity of the sensors, e.g., the sensors of gates 1, 2, and 3 within terminal A at LAX airport may be grouped together due to their proximate location with respect to one another, e.g., physical proximity within the same physical space, whereas sensors in different terminals are not grouped because of their disparate locations. However, in certain circumstances sensors within the same airport may be grouped together in order to monitor events at the airport as a whole and not at more granular level of terminals, gates, etc. It is further appreciated that other criteria may be used to group sensors and events together, e.g., sensor types, sensor readings, sensor proximity relative to other sensors, sensor locations, common paths in a structure past sensors, etc.

Representation of sensors (e.g., icons, images, shapes, rows, cells, etc.) may be displayed on a map and be operable for selection to be associated with an event. For example, five alerts with respect to five associated sensors within a particular vicinity may be displayed and an operator may select (e.g., highlight, click on, etc.) the five sensors (e.g., via lasso selection, click and drag selection, click selection, etc.) to group the sensors as an event. Alerts from the five sensors may then be displayed or sent as an event. A condition may also be applied to the group of five sensors such that an event is triggered based on one or more of the sensors in the group of five sensors satisfying a condition (e.g., reaching particular radiation level, exceeding a range of radiation readings, etc.).

In some embodiments, the sensor data representation module 210 may automatically select sensors to be associated as an event. For example, sensors within a 10 meters radius of each other within the same building can automatically be grouped so that alerts from the sensors will be indicated as an event.

The sensor data representation module 210 may access or receive one or more conditions, parameters, or heuristics via a graphical user interface, as input by an operator for instance, that may be used to configure the sensor process manager 204/state change manager 208 in determining an event. The one or more conditions, parameters, or heuristics may be received via the graphical user interface of a sensor data representation module 210, a sensor process manager 204, state change manager 208. The sensor data representation module 210 may determine whether an event has occurred based on an evaluation (e.g., a comparison, an algorithm, etc.) of the analyzed sensor data, the sensor metadata, and the one or more conditions, parameters, or heuristics. For example, sensors on a particular floor of a building may be selected as an event based on the associated location metadata of the sensors.

In another example, the parameters, conditions, or heuristics may be when metadata of sensors has substantially similar values or is within a range of particular values and/or the sensors are associated within a particular temporal time spans (e.g., number of minutes or hours interval over which sensor data is analyzed). Exemplary parameters may include, but are not limited to, building name, floor level, room number, geospatial coordinates within a given range (e.g., distance between sensors, proximity of sensors, etc.), sensor vendors, sensor type, sensor properties, sensor configuration, etc.

The heuristics may include a geographical range (e.g., sensors within a 20-30 meter range, larger range, etc.) or may be based on the time of travel or distance between particular sensors, etc. For example, if it normally takes people 30 minutes to pass through a security checkpoint then if any sensor within the security checkpoint has an alert state for a one minute interval or for a 30 minute interval an event based on the heuristics may be reported. An elevated or alert sensor state of 30 minutes may correspond to a particularly high radiation level that may be worth further investigation.

The heuristics may further include a distance between the sensors and proximity of the sensors. That is, the heuristics may be based on the time, distance, and proximity of the sensors. For example, if two adjacent sensors are sufficiently distant from each other so that radioactive material does not set off both sensors and a person traveling past the sensors would take at least 10 minutes to walk past both sensors, when alerts are generated based on both sensors in a particular order within 10 minutes, an associated event is generated.

An event and associated parameters, conditions, etc., may be based on the geographic proximity of the sensors. An event may thus allow focusing a user's attention (e.g., operator, administrator, etc.) on particular sensor data for a particular area. Metadata associated with the sensors including location, etc., may be used for event determination. For example, a single sensor based alert may be caused by an abnormality, background radiation, etc., while alerts from three, five, or seven sensors within 10 meters of each other may be indicative of a dangerous condition (e.g., hazardous material, hazardous cloud, etc.) that should be further analyzed or further attention directed thereto.

Based on determining that an event has occurred, an indicator may be output by the sensor data representation module 210. In some embodiments, the indicator may be output visually, audibly, or via a signal to another system (e.g., messaging system 108).

In some embodiments, an event may be configured with a parameter specifying where an event indicator should be sent. For example, an event indicator may be displayed in the GUI or the event indicator may be sent to an external system (e.g., messaging system 108).

The indicator may be based on one or more alerts from one or more sensors or an event based on alerts from multiple sensors. The events may be based on groups of sensors selected manually (e.g., via a GUI, command line interface, etc.) or automatically (e.g., based on an automatic grouping determined by the sensor based detection system 102), or based on heuristics. In some embodiments, the indicator (e.g., alert, event, message, etc.) may be output to a messaging system (e.g., messaging system 108 or messaging module 214). For example, the indicator may be output to notify a person (e.g., operator, administrator, safety official, etc.) or group of persons (e.g., safety department, police department, fire department, homeland security, etc.).

The sensor data representation module 210 may have various tools to “replay” after an event has occurred. The sensor data representation module 210 may further allow an operator to configure the sensor data representation module 210 to send alerts to external entities. For example, the operator can configure an XML interface to forward alerts and events to a local Fusion Center (e.g., of the federal government, another government office, etc.). The operator may further configure an SMS gateway or even a Twitter™ account to send alerts or events to.

In some embodiments, functionality of a sensor based detection system (e.g., sensor based detection system 102) may be invoked upon an event being determined. For example, a message may be sent, a determination of the path of travel of a hazardous material or condition, video displayed associated with sensor readings, an alarm signaled, etc.

The sensor interface module 212 may receive sensor associated data (e.g., sensor data, analyzed sensor data, and sensor metadata) from sensors 250-260 and/or sensor analytics processes 202. In some embodiments, the sensor interface module 212 receives analyzed sensor data from sensor analytics processes 202. The sensor interface module 212 may send the analyzed sensor data, sensor data, sensor metadata, etc., to the data store 206 for storage. The sensor interface module 212 may further send metadata associated with sensors 250-260 for storage in the data store 206 with the associated analyzed sensor data. In some embodiments, the sensor interface module 212 may send the analyzed sensor data, sensor data, and sensor metadata to the sensor data representation module 210. In some embodiments, the sensor interface module 212 sends the analyzed sensor data and metadata associated with sensors 250-260 to the sensor data representation module 210. It is appreciated that the information transmitted to the sensor data representation module 210 from the sensor interface module 212 may be in a message based format. The sensor interface module 212 may further send data determined from or based on analysis of the analyzed sensor data, sensor data, sensor metadata, etc., to sensor process manager 204, data store 206, sensor data representation module 210, etc.

In some embodiments, the sensor interface module 212 may access a configuration data store, receive data from one or more sensors 250-260, and analyze the data from the one or more sensors based on the configuration of the configuration data store to produce analyzed data. In some embodiments, the configuration data store may be a part of the data store 206, a part of the sensor interface module 212, or another data store (not shown). The configuration data store and configuration data thereof may be user configurable, as described below. The sensor interface module 212 may send the analyzed data to sensor process manager 204, sensor data representation module 210, etc. The analyzed data may include new algorithmic data points, new events configured for display on a graphical user interface, new events to be communicated via a messaging system, etc.

In some embodiments, the sensor interface module 212 is configured to allow customized formulas, algorithms, heuristics, rules, etc., to be applied to analyzed sensor data, sensor data, sensor metadata, etc. The sensor interface module 212 may apply the customized formulas, algorithms, heuristics, rules, etc., to data and/or metadata at a specific point in time, over a period of time, etc. The sensor interface module 212 may further apply the customized formulas, algorithms, heuristics, etc., to historical data. For example, the sensor interface module 212 may be used to apply an algorithm to determine whether a sensor state has changed and based on the change in sensor state, an event may be triggered. As another example, an event may be triggered based on multiple radiation sensor readings exceeding a range specified by a heuristic applied by the sensor interface module 212. The sensor interface module 212 may be configured via script files, configuration files, a graphical user interface, etc. For example, script code, compiled code, etc., or some combination thereof may be written, created, generated, etc., via a graphical user interface and executed to dynamically process the data received from the sensors 250-260. In some embodiments, the customized formulas, algorithms, heuristics, rules, etc., are configured for use in filtering data and calculating values for comparison to alert levels.

In some embodiments, the sensor interface module 212 may determine a state change based on the code of exemplary Table 1. If the state of a sensor has changed, a changed state is returned. If no state change has taken place, nothing is returned.

TABLE 1
Exemplary Code For State Change Formula

```
StateChangeFormula
package com.company.sensorsys.terminus
import akka.actor.ActorLogging
import hk.farmington.terminus.core.value.ValueCreateOne
import hk.farmington.terminus.plugin.FormulaActor
import scala.annotation.tailrec
import org.joda.time.DateTime
class ChunkStateChangeFormula extends FormulaActor with ActorLogging {
  case class Record(datetime: DateTime, systemState: Double, mSv: Double)
  // Add an empty record to the registry so we immediately fire when we get the first
data
  var registry: List[Record] = Record(new DateTime(0), Double.NaN, Double.NaN):
Nil
  override def receive = {
  case input: FormulaActor.Input =>
    registry ++ = update(input.datetime. input.values)
    if(log.isDebugEnabled) log.debug(s“Registry is now: \n * ${registry.mkString(“\n *
”)}”)
    import concurrent.duration._{—}
    import context.dispatcher
    context.system.scheduler.scheduleOnce(200 milliseconds) {
    self ! ChunkStateChangeFormula.Process
    }
  case ChunkStateChangeFormula.Process =>
    for(changed <- process(registry)) {
    if(log.isDebugEnabled) log.debug(s“State change ${changed.datetime}:
${changed.systemState} (${changed.mSv} mSv)”)
    context.parent | FormulaActor.Output(changed.datetime,
Map(“SYSTEM_STATE_CHANGE” -> changed.systemState, “MSV” ->
changed.mSv))
    }
    if(log.isDebugEnabled) log.debug(s“Registry after processing: \n *
${registry.mkString(“\n * ”)}”)
  }
  def update(datetime: DateTime, values: Map[String. ValueCreateOne]): List[Record]
= {
  if(log.isDebugEnabled) log.debug(s“Updating registry with values for $datetime: \n
${values.mkString(“\n”)}”)
  val converted = for {
    systemState <- values.get(“SYSTEM_STATE”)
    mSv <- values.get(“MSV”)
  } yield {
    Record(datetime, systemState.amount, mSv.amount)
  }
  if(log.isDebugEnabled) log.debug(s“Update yielded the following list: $converted”)
  converted.toList
  }
  def process(list: List[Record]): List[Record] = {
  @tailrec
  def collect(in: List[Record]. collected: List[Record] = List.empty): List[Record] = {
    in match {
    case Nil => collected
    case last :: Nil =>
      if(last.systemState < 0 && |collected.contains(last)) {
      collected :+ last
      } else collected
    case first :: tail =>
      val second = tail.head
      if(second.systemState == first.systemState) {
      registry = registry.filterNot(_.datetime == first.datetime)
      collected
      } else if(second.systemState != first.systemState) {
      registry = registry.filterNot(_.datetime == first.datetime)
      collect(tail, collected :+ second)
      } else collected
    }
  }
  val sorted = list.sortWith( (x,y) => x.datetime.isBefore(y.datetime))
  collect(sorted)
  }
}
object ChunkStateChangeFormula {
  private case object Process
}
```

In some embodiments, the state change formula may be applied to each location via a template trigger based on the code of exemplary Table 2. The template trigger may apply to sensors of a location that have the SYSTEM_STATE field defined. The trigger may generate an event for every change that occurs in the SYSTEM_STATE field.

TABLE 2
Exemplary Code For Template Trigger

```
Create Trigger Command
{
  “key”: “statetrigger”,
  “path”: “/somelocation”,
  “formula”: “com.company.sensorsys.terminus.StateChangeFormula”,
  “enabled”: true,
  “template”: true,
  “inputs”: [ “SYSTEM_STATE” ],
  “attributes”: { “name”: “State Change Trigger” }
}
```

The sensor interface module 212 may further generate new data based on applying the customized formulas, algorithms, heuristics, etc., to the sensor data, sensor metadata, analyzed sensor data, etc., and send the new data to the sensor process manager 204, the data store 206, and/or the sensor data representation module 210. For example, for radiation sensing, the sensor interface module 212 may apply heuristics to the radiation readings to determine a point of interest, e.g., consistent increases in radiation in localized geographic areas within a predetermined time.

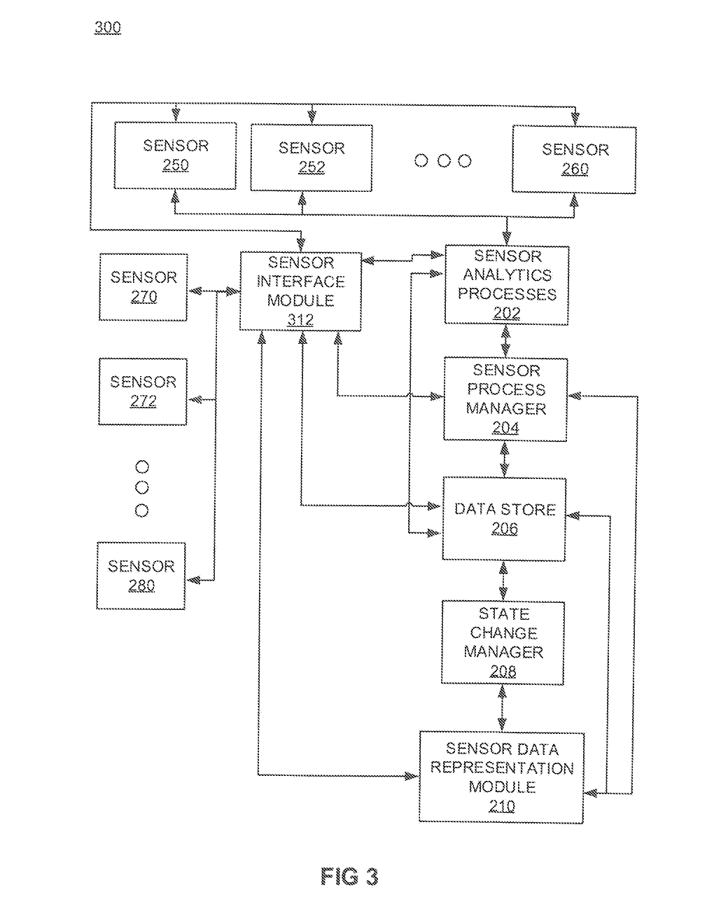

FIG. 3 shows an exemplary data flow diagram in accordance with some embodiments. Diagram 300 depicts the flow of data (e.g., sensor readings, raw sensor data, analyzed sensor data, etc.) associated with a sensor based detection system (e.g., sensor based detection system 102). Diagram 300 includes sensors 250-260, sensors 270-280, sensor analytics processes 202, a sensor process manager 204, a data store 206, a state change manager 208, a sensor data representation module 210, and a sensor interface module 312. In some embodiments, the sensor analytics processes 202, the sensor process manager 204, the state change manager 208, the sensor data representation module 210, and sensor interface module 312 may execute on one or more computing systems (e.g., virtual or physical computing systems). The data store 206 may be part of or stored in a data warehouse. The sensor interface module 312 may operate in substantially similar manner as the sensor interface module 212.

The sensors 250-260 may be substantially similar to sensors 110-120 and may be any of a variety of sensors as described above. The sensors 250-260 may provide data (e.g., as camera stream data, video stream data, etc.) to the sensor analytics processes 202 and/or the sensor interface module 312. The sensors 270-280 may be substantially similar to sensors 110-120 and may be any of a variety of sensors as described above. In some embodiments, the sensors 270-280 may be of a different type from the sensors 250-260. For example, the sensors 270-280 may be infrared sensors while sensors 250-260 may be radiation sensors. In some embodiments, the sensors 270-280 may be a variety of types of sensors including thermal sensors (e.g., temperature, heat, etc.), electromagnetic sensors (e.g., metal detectors, light sensors, particle sensors, Geiger counter, charge-coupled device (CCD), etc.), mechanical sensors (e.g. tachometer, odometer, etc.), complementary metal-oxide-semiconductor (CMOS), biological/chemical (e.g., toxins, nutrients, etc.), water, infrared, perimeters sensor (e.g., if contact with a fence has been made), pressure sensor, contact plate, etc. The sensor interface module 312 may be configured to handle processing of data from multiple different types of sensors (e.g., sequentially, simultaneously, etc.).

In some embodiments, the sensor interface module 312 may determine data (e.g., a value, a data point, etc.) based on a correlation between multiple types of sensors. For example, radiation and water sensor readings may be combined in a calculation based on the sensor reading performed because of an observed correlation between the radiation sensor data and water reading sensor data. As another example, based on historical data a correlation between radiation sensor readings and water height reading of 0.5 may have been determined to have a particular meaning. The sensor interface module 312 may thus apply an algorithm to multiple different types of sensor based data (e.g., sensor data, sensor metadata, analyzed sensor data, etc.) and generate events, values, data points, etc., based on the sensor based data matching particular conditions of the algorithm.

The sensor interface module 312 may further be configured to determine whether a false positive has been detected. For example, a facility may have a shielded room with radioactive material and when a door to the shielded room is opened, a sensor registers an elevated radiation reading. The sensor interface module 312 may be configured to determine that a limited duration change in radiation readings and/or sensor state of a particular radiation sensor is a non-event, a false positive, etc., whereas a longer change in radiation readings and/or sensor state of a particular radiation sensor is an event. The event may be sent to the sensor process manager 204, the data store 206, and the sensor data representation module 210.

In some embodiments, the sensor interface module 312 is configured for relating seemingly unrelated entities together to allow creation of a combined entity, combined event, combined trigger, etc. For example, the water height level exceeding a first threshold and the temperature of certain equipment exceeding a second threshold may be treated as a combined event of high importance which is then sent to one or more of the sensor process manager 204, data store 206, and/or sensor data representation module 210.

In some embodiments, the sensor interface module 312 may be configured to make determinations, calculations, etc., based on the historical data. For example, the sensor interface module 312 may be used to analyze data points within a specific date and/or time range of a stored stream of sensor data and perform a calculation on each data point of the stream to generate an event or a new data point. As another example, an event may be generated based on multiple sensor infrared readings exceeding an object size range as determined by an algorithm applied by the sensor interface module 212. The event and/or the new data point may then be sent to one or more of the sensor process manager 204, data store 206, and/or sensor data representation module 210.

In some embodiments, the sensor interface module 312 is configurable for adding new sensor states. The states may be based on threshold, ranges, etc., as described above. For example, if there are six sensor states of calibrating, nominal, elevated, potential, warning, and danger, the sensor interface module 312 may be used to add a seventh sensor state of extreme danger. In some embodiments, the sensor states may be based on a government mandated standard, a certification standard, etc. For example, a carbon emissions formula based on a government mandated standard may be used by the sensor interface module 312 to determine a sensor state.

In some embodiments, the sensor interface module 312 is configured for adding new sensors of different types. For example, the components of diagram 300 may be configured as a radiation sensing platform from a user interface standpoint with five or six sensor states and the sensor interface module 312 may be used to add water level sensors and one or more states associated with one or more water levels based on readings from the water level sensors. Exemplary water levels may include dry, normal, flooded, etc. The sensor interface module 312 may further be used to define how the water sensor levels will be represented in the user interface and what alerts are associated with various water levels (e.g., based on a configuration file). The sensor interface module 312 may further be used to add additional types of sensors including sensors that may not have been present within or in existence at the time of creation and/or installation of system 200 or sensor based detection system 102. As another example, one or more chemical sensors may be added to the system of diagram 200 and the sensor interface module 312 to create the system of diagram 300. The sensor interface module 312 may be used to configure one or more algorithms for determining a chemical sensor state and associated event with an elevated sensor state.

In some embodiments, a graphical user interface component (not shown) of a sensor process manager 204, a sensor data representation module 210, etc., and/or the sensor interface module 312 may be used to configure, define, etc., how the type of sensor being added to the system works and configuring the sensor interface module 312, as described herein.

The sensor interface module 312 may be configured for determining how different sensor readings are represented graphically and how different sensor readings are represented in a data structure. For example, a first set of colors may be used for representing radiation sensor readings on radiation sensor icons and a second set of colors may be used for representing water sensor readings on water sensor icons. As another example, the sensor interface module 312 may be used to configure a low state of 1 foot of water to be associated with yellow, a normal state for a water sensor may be three feet of water to be associated with green, an elevated state for a water sensor may be five feet of water to be associated with pink, and a flooding state for a water sensor may be over five feet of water to be associated with red. The sensor interface module 312 may thus be used to configure what is normal, what is an alert, and what are the different reading levels for one or more sensors and/or sensor types.

In some embodiments, one or more instances of the sensor interface module 312 may be used for different types of sensors. For example, a first instance of the sensor interface module 312 may be used for infrared sensors configured for detecting movement and a second instance of the sensor interface module 312 used for water sensors. The first instance of the sensor interface module 312 may be used to determine how infrared sensors are to be communicated with (e.g., by sensor process manager 204, etc.), how infrared sensor operational states are determined, configure the sensitivity of the sensors, and how to receive metadata (e.g., the location, floor, etc. where an infrared sensor is located). As another example, an alert based on the infrared sensor may be based on a heat signature being within a particular size range. The use of a particular size range may be used to avoid false positives based on a small animals (e.g., cats, rats, etc.) when an alert is to be based on a detection of a human being.

The sensor interface module 312 may further be used to determine sensor states including operational, down, malfunctioning, etc. For example, a water sensor that is configured to provide data on a periodic schedule of 30 seconds may be determined by the sensor interface module 312 to be malfunctioning when data has not been provided for more than one and a half minutes. As another example, the water sensor may be determined by the sensor interface module 312 to be operational upon receiving a water sensor data reading within the last forty-five seconds.

The sensor interface module 312 may be configured for use with a sensor that is configured to be polled and with sensors that push data. For example, a sensor that is configured to be polled may be queried by the sensor interface module 312 at periods of one second, ten seconds, and fifteen seconds. As another example, a sensor that is configured to push data may provide data upon a particular sensor reading (e.g., an infrared sensor sending data based on detecting movement) to the sensor interface module 312.

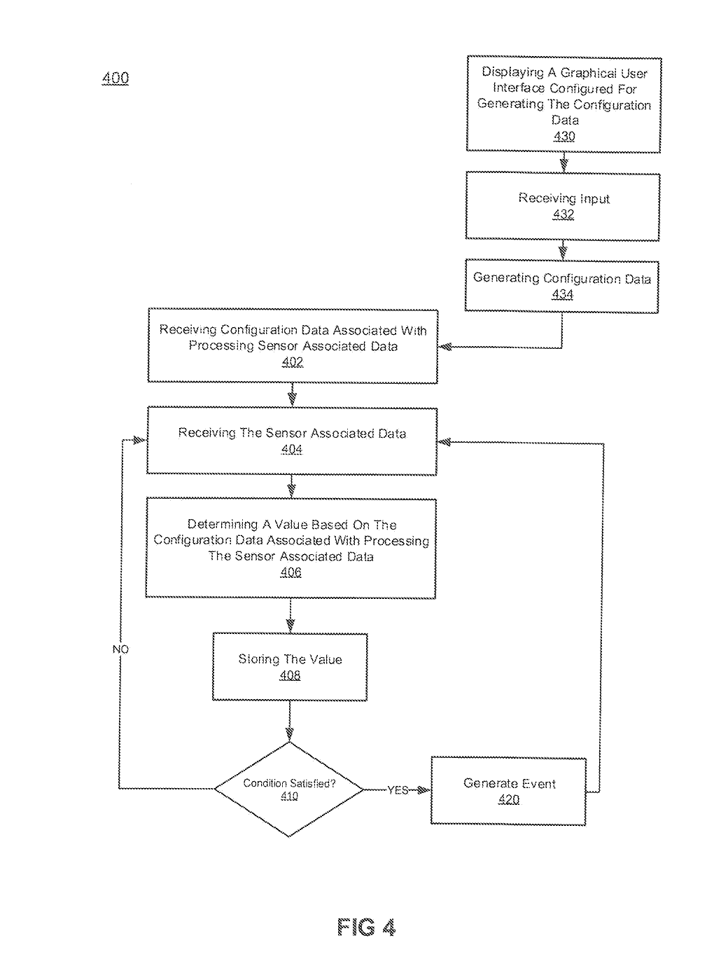

FIG. 4 shows an exemplary flow diagram of a process for processing data associated with a sensor in accordance with some embodiments. FIG. 4 depicts a process 400 for processing of data associated with a sensor by a component configured for communicating with a sensor and configured for processing data from and associated with a sensor. In some embodiments, process 400 may be performed by a sensor interface module (e.g., sensor interface module 212, sensor interface module 312, etc.).

At block 402, configuration data associated with processing sensor associated data is received. In some embodiments, the processing of the sensor associated data is customized based on the configuration data, as described above.

At block 404, the sensor associated data is received, as described above. The sensor data may include raw sensor data, analyzed sensor data, and sensor metadata.

At block 406, a value is determined based on the configuration data associated with processing the sensor associated data, as described above. The value may be a sensor reading, a correlation, an event, output based on a formula, heuristics, algorithms, rules, etc., as described above. In some embodiments, the determining of the value is based on historical sensor associated data and the sensor associated data received from a sensor. In some embodiments, the value is further based on a change in state of the sensor, as described above.

At block 408, the value is stored. In some embodiments, the value may be stored in a data store, data warehouse, etc. The value may be stored for access by other components (e.g., sensor process manager 204, state change manger 208, sensor data representation module 210, etc.). In some embodiments, the value is based on a heuristic of the configuration data, as described above. In some embodiments, the value is associated with an event, as described above.

At block 410, whether a condition is satisfied may be determined (e.g., by sensor interface module 212, sensor interface module 312, etc.). In some embodiments, the condition may be based on one or more formulas, algorithms, heuristics, rules, etc., as described above. If the condition is satisfied, an event is generated, at block 420. For example, an event may be generated based on multiple water height sensor readings exceeding a height threshold specified by a formula applied by the sensor interface module 212. If the condition is not satisfied, block 404 may be performed.

At optional block 430, a graphical user interface (GUI) configured for generating the configuration data is displayed. The GUI may allow for creating, entering, etc., of a configuration based on graphical selections (e.g., via dropdown boxes, text boxes, etc.), creating of script code, compiling of code, etc., as described above.

At optional block 432, input is received. As described above, the input may include code (e.g., compiled code, script code, etc.), values input via a graphical user interface, command line interface (CLI) input, etc.

At optional block 434, configuration data is generated. The generation may be based on the input, as described above. The configuration data may be generated, configured, formatted, etc., for use in interpreting, processing, etc., sensor associated data from one or more types of sensors, as described above.

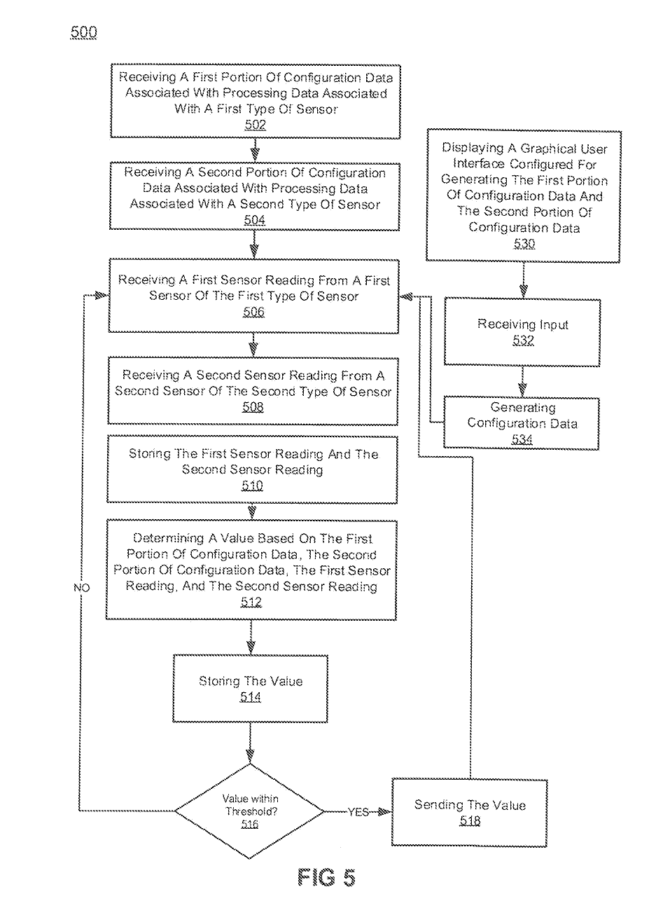

FIG. 5 shows another exemplary flow diagram of a process for processing data from different sensor types in accordance with some embodiments. FIG. 5 depicts a process 500 for processing of data associated with a sensor by a component configured for communicating with multiple types of sensors and configured for processing data from multiple types of sensors. In some embodiments, the process 500 may be performed by a sensor interface module (e.g., sensor interface module 312).

At block 502, a first portion of configuration data associated with processing data associated with a first type of sensor is received. At block 504, a second portion of configuration data associated with processing data associated with a second type of sensor is received. For example, the first portion of configuration data may be associated with radiation sensors and the second portion of configuration data may be associated with infrared sensors. In some embodiments, the first portion of configuration data and the second portion of configuration data may be stored in separate files, locations, etc.

At block 506, a first sensor reading from a first sensor of the first type of sensor is received, as described above. At block 508, a second sensor reading from a second sensor of the second type of sensor is received, as described above.

At block 510, the first sensor reading and the second sensor reading are stored. In some embodiments, the sensor readings may be stored in a data store, data warehouse, etc. The sensor readings may be stored for access by other components (e.g., sensor process manager 204, state change manger 208, sensor data representation module 210, etc.).

At block 512, a value is determined based on the first portion of configuration data, the second portion of configuration data, the first sensor reading, and the second sensor reading. The value may be a sensor reading, a correlation, an event, output based on a formula, heuristics, algorithms, rules, etc., as described above. In some embodiments, the value is based on a correlation between the first sensor reading and the second sensor reading. In some embodiments, the value is an event based on the correlation between the first sensor reading and the second sensor reading. In some embodiments, the value is based on an algorithm applied to the first sensor reading and the second sensor reading.

At block 514, the value is stored. In some embodiments, the value may be stored in a data store, data warehouse, etc. The value may be stored for access by other components (e.g., sensor process manager 204, state change manger 208, sensor data representation module 210, etc.).

At block 516, whether the value is within a threshold is determined. In some embodiments, the threshold may be a range, an event associated threshold, value, etc., an alert associated threshold, value, etc. In some embodiments, the condition may be based on one or more formulas, algorithms, heuristics, rules, etc. as described above. If the threshold condition is satisfied, block 518 may be performed. If the threshold condition is not satisfied, block 506 may be performed.

At block 518, in response to determining the value meets threshold condition, the value is sent, as described herein. In some embodiments, the value may be sent to another component (e.g., sensor process manager 204, state change manger 208, sensor data representation module 210, etc.).

At optional block 530, a graphical user interface (GUI) configured for generating the first portion of configuration data and the second portion of configuration data is displayed. The GUI may allow for creating, entering, etc. of a configuration based on graphical selections (e.g., via dropdown boxes, text boxes, etc.), creating of script code, compiling of code, etc., as described above.

At optional block 532, input is received. As described above, the input may include code (e.g., compiled code, script code, etc.), values input via a GUI, command line interface (CLI) input, etc.

At optional block 534, configuration data is generated. The generation may be based on the input, as described above. The configuration data may be generated, configured, formatted, etc., for use in interpreting, processing, etc., sensor associated data from one or more types of sensors, as described above.

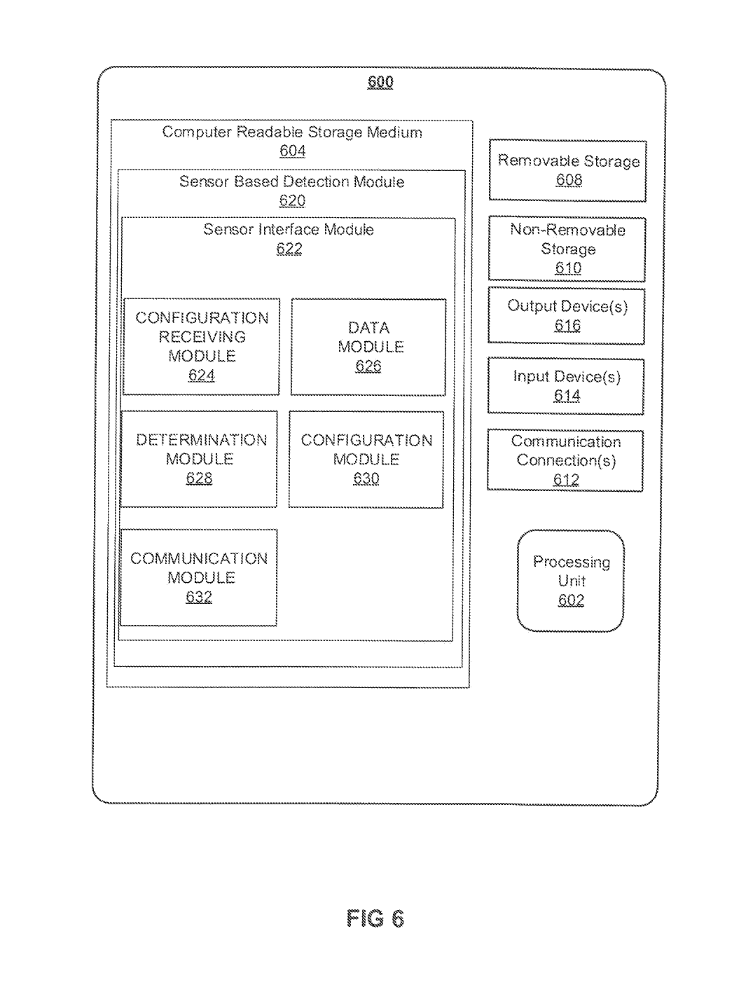

Referring now to FIG. 6, a block diagram of an exemplary computer system in accordance with some embodiments is shown. With reference to FIG. 6, an exemplary system module for implementing embodiments disclosed above, such as the embodiments described in FIGS. 1-5. In some embodiments, the system includes a general purpose computing system environment, such as computing system environment 600. The computing system environment 600 may include, but is not limited to, servers, desktop computers, laptops, tablets, mobile devices, and smartphones. In its most basic configuration, the computing system environment 600 typically includes at least one processing unit 602 and computer readable storage medium 604. Depending on the exact configuration and type of computing system environment, computer readable storage medium 604 may be volatile (such as RAM), non-volatile (such as ROM, flash memory, etc.) or some combination of the two. Portions of computer readable storage medium 604 when executed facilitate monitoring, management of sensors, and sensor analytics processes according to embodiments described above (e.g., processes 400-500).

Additionally in various embodiments, computing system environment 600 may also have other features/functionality. For example, computing system environment 600 may also include additional storage (removable and/or non-removable) including, but not limited to, magnetic or optical disks or tape. Such additional storage is illustrated by removable storage 608 and non-removable storage 610. Computer storage media includes volatile and nonvolatile, removable and non-removable media implemented in any method or technology for storage of information such as computer readable instructions, data structures, program modules or other data. Computer readable medium 604, removable storage 608 and nonremovable storage 610 are all examples of computer storage media. Computer storage media includes, but is not limited to, RAM, ROM, EEPROM, flash memory or other memory technology, expandable memory (e.g. USB sticks, compact flash cards, SD cards), CD-ROM, digital versatile disks (DVD) or other optical storage, magnetic cassettes, magnetic tape, magnetic disk storage or other magnetic storage devices, or any other medium which can be used to store the desired information and which can be accessed by computing system environment 600. Any such computer storage media may be part of computing system environment 600.

In some embodiments, computing system environment 600 may also contain communications connection(s) 612 that allow it to communicate with other devices. Communications connection(s) 612 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. The term computer readable media as used herein includes both storage media and communication media.

Communications connection(s) 612 may allow computing system environment 600 to communicate over various networks types including, but not limited to, fibre channel, small computer system interface (SCSI), Bluetooth, Ethernet, Wi-Fi, Infrared Data Association (IrDA), Local area networks (LAN), Wireless Local area networks (WLAN), wide area networks (WAN) such as the internet, serial, and universal serial bus (USB). It is appreciated the various network types that communication connection(s) 612 connect to may run a plurality of network protocols including, but not limited to, transmission control protocol (TCP), user datagram protocol (UDP), internet protocol (IP), real-time transport protocol (RTP), real-time transport control protocol (RTCP), file transfer protocol (FTP), and hypertext transfer protocol (HTTP).

In further embodiments, computing system environment 600 may also have input device(s) 614 such as keyboard, mouse, a terminal or terminal emulator (either directly connected or remotely accessible via telnet, SSH, HTTP, SSL, etc.), pen. Voice input device, touch input device, remote control, etc. Output device(s) 616 such as a display, a terminal or terminal emulator (either directly connected or remotely accessible via telnet, SSH, HTTP, SSL, etc.), speakers, LEDs, etc. may also be included.

In some embodiments, the computer readable storage medium 604 includes a sensor based detection module 620. The sensor based detection module 620 is configured for monitoring and management of a plurality of sensors and associated analytics (e.g., sensor based detection system 102). In some embodiments, the sensor based detection module 620 includes a sensor interface module 622. The sensor interface module 622 is configured for communicating with one or more sensors, receiving sensor associated data, processing, interpreting, etc., of the sensor associated data, managing the collection, reporting, and display of sensor readings.

The sensor interface module 622 includes a configuration receiving parameter module 624, a data module 626, a determination module 628, a configuration module 630, and a communication module 632.

The configuration receiving module 624 is configured for receiving configuration data associated with processing of the data associated with a plurality of sensors. In some embodiments, the plurality of sensors comprises a first sensor of a first sensor type and a second sensor of a second sensor type. The data module 626 is configured to receive data associated with the plurality of sensors. The determination module 628 is configured for determining a data point based on the configuration data associated with processing of the data associated with the plurality of sensors applied to the data associated with the plurality of sensors. In some embodiments, the data point is an event. The communication module 632 is configured for sending the data point. The configuration module 630 is for outputting configuration data associated with processing the data associated with the plurality of sensors. In some embodiments, the configuration module 630 is further for displaying a graphical user interface (GUI) for generating the configuration data associated with processing the data associated with the plurality of sensors.

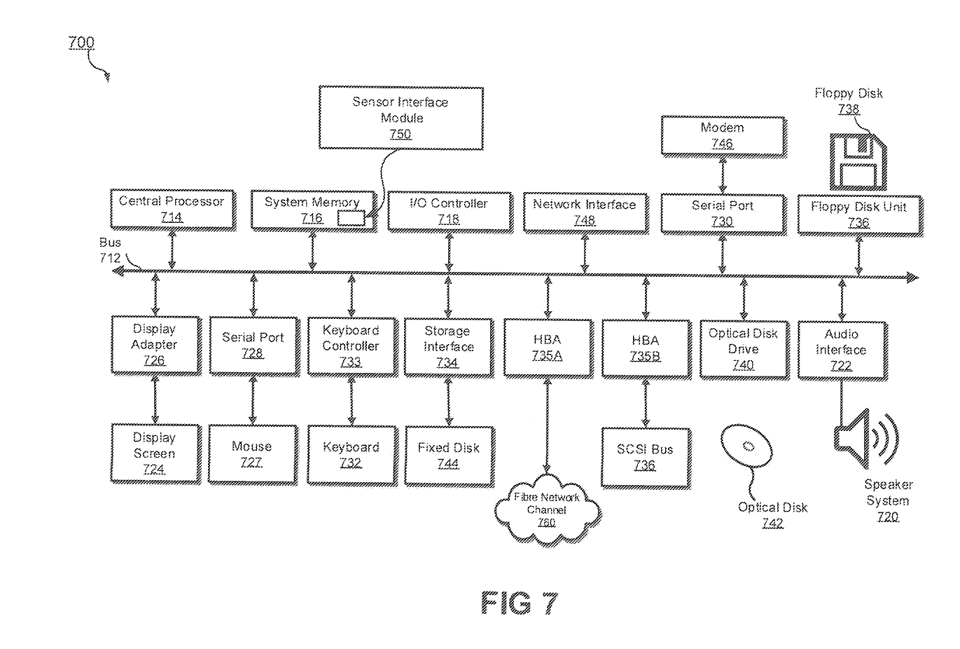

Referring now to FIG. 7, a block diagram of another exemplary computer system in accordance with some embodiments is shown. FIG. 7 depicts a block diagram of a computer system 700 suitable for implementing the present disclosure. Computer system 700 includes a bus 712 which connects the major subsystems of the computer system 700, such as a central processor 714, a system memory 716 (typically RAM, but which may also include ROM, flash RAM, or the like), an input/output controller 718, an external audio device, such as a speaker system 720 via an audio output interface 722, an external device, such as a display screen 724 via a display adapter 726, serial ports 728 and 730, a keyboard 732 (interfaced with a keyboard controller 733), a storage interface 734, a floppy disk drive 736 operative to receive a floppy disk 738, a host bus adapter (HBA) interface card 735A operative to connect with a Fibre Channel network 760, a host bus adapter (HBA) interface card 7358 operative to connect to a Small Computer System Interface (SCSI) bus 736, and an optical disk drive 740 operative to receive an optical disk 742. Also included are a mouse 727 (or other point-and-click device, coupled to bus 712 via serial port 728), a modem 746 (coupled to bus 712 via serial port 730), and a network interface 748 (coupled directly to bus 712).

It is appreciated that the network interface 748 may include one or more Ethernet ports, wireless local area network (WLAN) interfaces, etc., but is not limited thereto. System memory 716 includes a sensor interface module 750 configured for communicating with one or more sensors, receiving sensor associated data, processing, interpreting, etc., of the sensor associated data, managing the collection, reporting, and display of sensor readings. According to some embodiments, the sensor interface module 750 may include other modules for carrying out various tasks (e.g., modules of FIG. 6). It is appreciated that the sensor interface module 750 may be located anywhere in the system and is not limited to the system memory 716. As such, residing within the system memory 716 is merely exemplary and not intended to limit the scope of the embodiments. For example, parts of the sensor interface module 750 may be located within the central processor 2414 and/or the network interface 2448 but are not limited thereto.

The bus 712 allows data communication between the central processor 714 and the system memory 716, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS), which controls basic hardware operation such as the interaction with peripheral components. Applications resident with computer system 700 are generally stored on and accessed via a computer readable medium, such as a hard disk drive (e.g., fixed disk 744), an optical drive (e.g., optical drive 740), a floppy disk unit 736, or other storage medium. Additionally, applications can be in the form of electronic signals modulated in accordance with the application and data communication technology when accessed via network modem 746 or network interface 748.

The storage interface 734, as with the other storage interfaces of computer system 700, can connect to a standard computer readable medium for storage and/or retrieval of information, such as a fixed disk drive 744. A fixed disk drive 744 may be a part of computer system 700 or may be separate and accessed through other interface systems. The network interface 748 may provide multiple connections to networked devices. Furthermore, a modem 746 may provide a direct connection to a remote server via a telephone link or to the Internet via an Internet service provider (ISP). The network interface 748 provides one or more connections to a data network, which may consist of any number of other network-connected devices. The network interface 748 may provide such connection using wireless techniques, including digital cellular telephone connection, Cellular Digital Packet Data (COPD) connection, digital satellite data connection or the like.

Many other devices or subsystems (not shown) may be connected in a similar manner (e.g., document scanners, digital cameras and so on). Conversely, not all of the devices shown in FIG. 7 need to be present to practice the present disclosure. The devices and subsystems can be interconnected in different ways from that shown in FIG. 7. Code to implement the present disclosure can be stored in computer-readable storage media such as one or more of system memory 716, fixed disk 744, optical disk 742, or floppy disk 738. The operating system provided on computer system 700 may be MS-DOS®, MS-WINDOWS®, OS/2®, UNIX®, Linux®, or any other operating system.

Moreover, regarding the signals described herein, those skilled in the art will recognize that a signal can be directly transmitted from a first block to a second block or a signal can be modified (e.g., amplified, attenuated, delayed, latched, buffered, inverted, filtered, or otherwise modified) between the blocks. Although the signals of the above described embodiments are characterized as transmitted from one block to the next, other embodiments of the present disclosure may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

The foregoing description, for purpose of explanation, has been described with reference to specific embodiments. However, the illustrative discussions above are not intended to be exhaustive or to limit the embodiments to the precise forms disclosed. Many modifications and variations are possible in view of the above teachings.

What is claimed is:

1. A method comprising:
receiving configuration data associated with processing sensor associated data;
receiving the sensor associated data;
determining a value based on the configuration data associated with processing the sensor associated data; and
storing the value.

2. The method as described in claim 1, wherein the determining of the value is based on historical sensor associated data and the sensor associated data received from a sensor.

3. The method as described in claim 2, wherein the value is further based on a change in a state of the sensor.

4. The method as described in claim 1, wherein the processing of the sensor associated data is customized based on the configuration data.

5. The method as described in claim 1 further comprising:
displaying a graphical user interface configured for generating the configuration data.

6. The method as described in claim 1, wherein the value is based on a heuristic of the configuration data.

7. The method as described in claim 1, wherein the value is associated with an event.

8. A method comprising:
receiving a first portion of configuration data associated with processing data associated with a first type of sensor;
receiving a second portion of configuration data associated with processing data associated with a second type of sensor;
receiving a first sensor reading from a first sensor of the first type of sensor;
receiving a second sensor reading from a second sensor of the second type of sensor;
determining a value based on the first portion of configuration data, the second portion of configuration data, the first sensor reading, and the second sensor reading; and
storing the value.

9. The method as described in claim 8 further comprising:
determining whether the value is within a threshold; and
in response to determining the value is within a threshold, sending the value.

10. The method as described in claim 8, wherein the value is based on a correlation between the first sensor reading and the second sensor reading.

11. The method as described in claim 10, wherein the value is an event based on the correlation between the first sensor reading and the second sensor reading.

12. The method as described in claim 8 further comprising:
storing the first sensor reading and the second sensor reading.

13. The method as described in claim 8 further comprising:
displaying a graphical user interface configured for generating the first portion of configuration data and the second portion of configuration data.

14. The method as described in claim 8, wherein the value is based on an algorithm applied to the first sensor reading and the second sensor reading.

15. A system comprising:
a data module configured to receive data associated with a plurality of sensors;
a configuration receiving module configured for receiving configuration data associated with processing of the data associated with the plurality of sensors; and
a determination module configured for determining a data point based on the configuration data associated with processing of the data associated with the plurality of sensors applied to the data associated with the plurality of sensors.

16. The system of claim 15, wherein the plurality of sensors comprises a first sensor of a first sensor type and a second sensor of a second sensor type.

17. The system of claim 15 further comprising:
a communication module for sending the data point.

18. The system of claim 15, wherein the data point is an event.

19. The system of claim 15 further comprising:
a configuration module for outputting configuration data associated with processing the data associated with the plurality of sensors.

20. The system of claim 19, wherein the configuration module is further for displaying a graphical user interface for generating the configuration data associated with processing the data associated with the plurality of sensors.
